(19) United States
(12) Patent Application Publication
(10) Pub. No.: US 2008/0209677 A1
(43) Pub. Date: Sep. 4, 2008

(54) FURNITURE HINGE

(75) Inventors: Markus Herper, Muhltal (DE); Remo Egger, Langenegg (AT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Mepla-Werke Lautenschlager GmbH & Co. KG, Reinheim (DE)

(21) Appl. No.: 12/099,865

(22) Filed: Apr. 9, 2008

Related U.S. Application Data
(63) Continuation of application No. PCT/AT2007/000320, filed on Jun. 28, 2007.

(30) Foreign Application Priority Data
Jul. 3, 2006 (AT) A 1114/2006

(51) Int. Cl. E05D 7/00

(52) U.S. Cl. 16/233

(57) ABSTRACT

A furniture hinge including a carcass hinge part (2) that can be fastened to a furniture carcass (1), a door leaf hinge part (3) that can be fastened to a door leaf (3), and at least one articulated lever (5, 6) for the articulated connection of the carcass hinge part (2) to the door leaf hinge part (4), with the articulated lever (5, 6) being connected to a hinge arm (11) of the carcass hinge part (2) such that it can pivot around a pivot axis (7, 9). The hinge arm (11) is adjustable for the depth adjustment of the door leaf (3) in reference to the furniture carcass (1) in a direction of its longitudinal direction in reference to a retaining part (16) of the carcass hinge part (2) via an eccentric (14) acting between the hinge arm (11) and the retaining part (16), with its pivot axis (23) being aligned parallel in reference to the pivot axis (7, 9) of at least one articulated lever (5, 6).

### CROSS-REFERENCE TO RELATED APPLICATIONS

This application is a continuation of PCT/AT2007/000320, filed Jun. 28, 2007, which claims the benefit of Austrian Patent Application A 1114/2006, filed Jul. 3, 2006, both of which are incorporated by reference herein as if fully set forth.

### BACKGROUND

The invention relates to a furniture hinge comprising a carcass hinge part that can be fastened to a furniture carcass, a door leaf hinge part that can be fastened to a door leaf, and at least one articulated lever for the articulated connection of the carcass hinge part to the door leaf hinge part, wherein the articulated lever is connected to a hinge arm of the carcass hinge part such that it can pivot around a pivot axis and the hinge arm can be adjusted for the depth adjustment of the door leaf in reference to the furniture carcass in the longitudinal direction in reference to a retaining part of the carcass hinge part, with the hinge arm being adjustable in reference to the retaining part for depth adjustment via an eccentric acting between the hinge arm and the retaining part.

For the depth adjustment of a furniture hinge it is known to adjust the hinge arm of the carcass hinge part, at which at least one articulated lever of the furniture hinge is mounted in a pivotal manner, in reference to the retaining part of the carcass hinge part in the longitudinal direction of the hinge arm. For this purpose, in conventional hinges of the type mentioned at the outset, a type of clamping screw, which penetrates an oblong slot in the hinge arm and is screwed into a threaded bore of the retaining part, is loosened and retightened after the desired adjustment of the hinge arm. Here, it is disadvantageous that the door leaf must be held in the adjusted position of the hinge arm when the clamping screw is loosened until the clamping screw is again screwed tight. For example, the clamping part is embodied as a clip, which can be snapped onto a clip accept of an assembly plate (=assembly rack) of the furniture hinge. An assembly plate and a clip embodied in this manner are described, for example, in DE 299 02 768 U1.

EP 1 028 213 B1 shows another furniture hinge in which, for the depth adjustment, the hinge arm is adjustable in the direction of its longitudinal direction in reference to a retaining part. For the lateral adjustment (support adjustment), the angular position of the hinge arm in reference to a first intermediate plate is adjustable via an adjustment screw. The first intermediate plate is guided on the second intermediate plate, displaceable in the longitudinal direction for depth adjustment and can be fixed in reference to said second intermediate plate via a fastening screw, which penetrates an oblong hole in the first intermediate plate and can be screwed into a threaded bore of the second intermediate plate.

Additional furniture hinges, in which for the depth adjustment two parts of the carcass hinge part can be displaced in reference to each other in the longitudinal direction of the hinge arm and can be fixed via clamping screws, are known from DE 203 06 716 U1, DE 20 2004 013 401 U1, and EP 1 236 853 A1. In the furniture hinges of DE 203 06 716 U1 and EP 1 236 853 A2 an additional vertical adjustment occurs via an eccentric or a curved disk. Further, in the furniture hinge according to DE 20 2004 013 401 U1 a lateral adjustment (support adjustment) occurs via an adjustment screw, by which two parts of the assembly plate can be pivoted in reference to each other.

An assembly plate of a furniture hinge is further known from DE 201 20 238 U1, which is provided with first and second eccentrics, by which a clip accepting part can be adjusted in reference to a screw plate in directions that are perpendicular in reference to each other, in order to perform a depth adjustment and a vertical adjustment. A clip part connected to the hinge arm of the carcass hinge part can be snapped onto the clip accepting part. The screw of the eccentric for the depth adjustment is arranged between two lateral bars of the clip part and its rotational axis is aligned perpendicular in reference to the contact plane of the carcass hinge part at the furniture carcass. For the adjustment via an appropriate screw driver corresponding openings must be provided in the clip part and in the hinge arm and the space between these openings and the eccentric must be kept clear to allow access to the eccentric. This further narrows the already small space for installation in the carcass hinge part. Sufficient space in the carcass hinge part would be beneficial, in order to implement, for example, dampening cylinders or spring mechanisms in the carcass hinge part.

EP 1 288 416 shows a generic furniture hinge with an eccentric for the depth adjustment.

### SUMMARY

The invention provides a simply designed adjustable hinge of the type mentioned at the outset, in which in the carcass hinge part respective space can be kept clear for other built in parts.

According to the invention, the pivot axis of the eccentric is positioned parallel in reference to the pivot axis of at least one articulated lever.

The invention allows a simple depth adjustment, with space being kept clear in the carcass hinge part for other built in parts.

In a preferred embodiment of the invention, another eccentric is provided for the lateral adjustment (=support adjustment) of the door leaf in reference to the furniture carcass, by which the hinge part is adjustable in reference to the retaining part, with the axis of rotation of this additional eccentric also being positioned parallel in reference to the pivotal axes of at least one articulated lever. By this additional eccentric the hinge arm can be pivoted around a pivot axis in reference to the retaining part of the carcass hinge part, with the pivot axis being aligned parallel in reference to the pivot axis of the other eccentric, thus parallel to the pivot axes of at least one articulated lever. This way even a simple lateral adjustment is possible, with in turn space for other built in parts being kept clear in the carcass hinge part.

Advantageously, the space kept clear in the carcass hinge part can extend, from the end facing the door leaf hinge part, over a major part of the longitudinal extension of the carcass hinge part.

Preferably, the hinge arm is guided in a displaceable manner in reference to the retaining part by at least one pin, which engages an oblong hole extending essentially in the direction of the longitudinal direction of the hinge arm. At least one pin can be mounted to the retaining part or to the hinge arm and the oblong hole can be arranged at the respective other one of these two parts.

### BRIEF DESCRIPTION OF THE DRAWINGS

In the following, additional advantages and details of the invention are explained using the attached drawing.

In the drawings:

FIG. 1 is a side view of an exemplary embodiment of a furniture hinge according to the invention in the assembled state with furniture doors closed;

FIG. 2 is a perspective view of an assembled furniture hinge of FIG. 1;

FIG. 3 is a view of the furniture hinge of FIG. 2 in a modified adjustment for the depth adjustment;

FIG. 4 is a view of the furniture hinge of FIG. 2 in a modified position for the lateral adjustment;

FIG. 5 is a view of the furniture hinge of FIG. 2, in which the carcass hinge part is shown cross-sectioned in the longitudinal direction;

FIG. 6 is a view according to FIG. 5 in the opened state of the door leaf;

FIGS. 7 and 8 are perspective views of the furniture hinge in the closed and opened state;

FIG. 9 is an exploded perspective view of the furniture hinge, with parts of the carcass hinge part being shown separated;

FIG. 10 is a view according to FIG. 9 in the opened state of the furniture hinge;

FIG. 11 is a view of a slightly modified embodiment of an eccentric;

FIG. 12 is a side view, partially in cross-section, of another embodiment of the furniture hinge according to the invention in the assembled state with closed door leafs; and

FIG. 13 is an exploded perspective view of the carcass hinge part of the furniture hinge of FIG. 12, with parts of the carcass hinge part being shown separated.

### DETAILED DESCRIPTION OF THE PREFERRED EMBODIMENTS

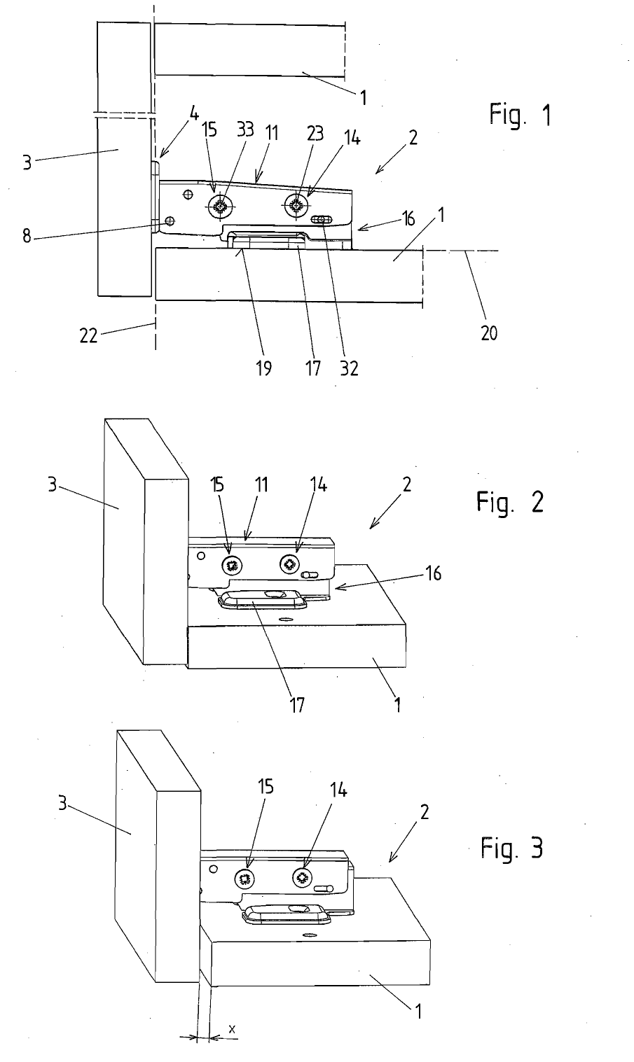

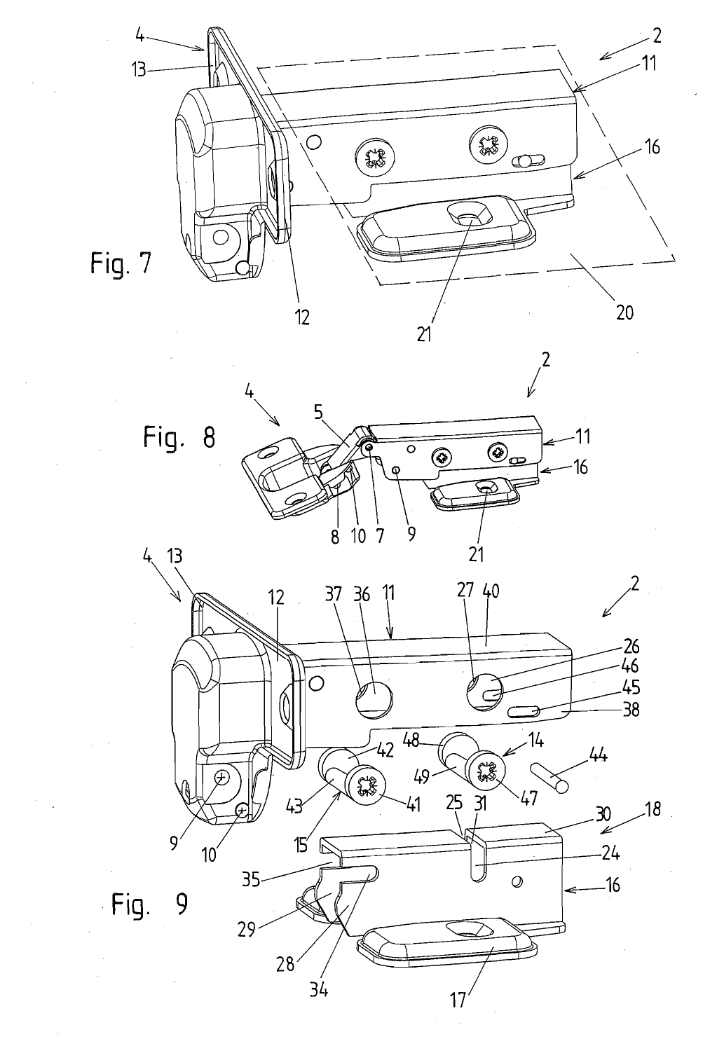

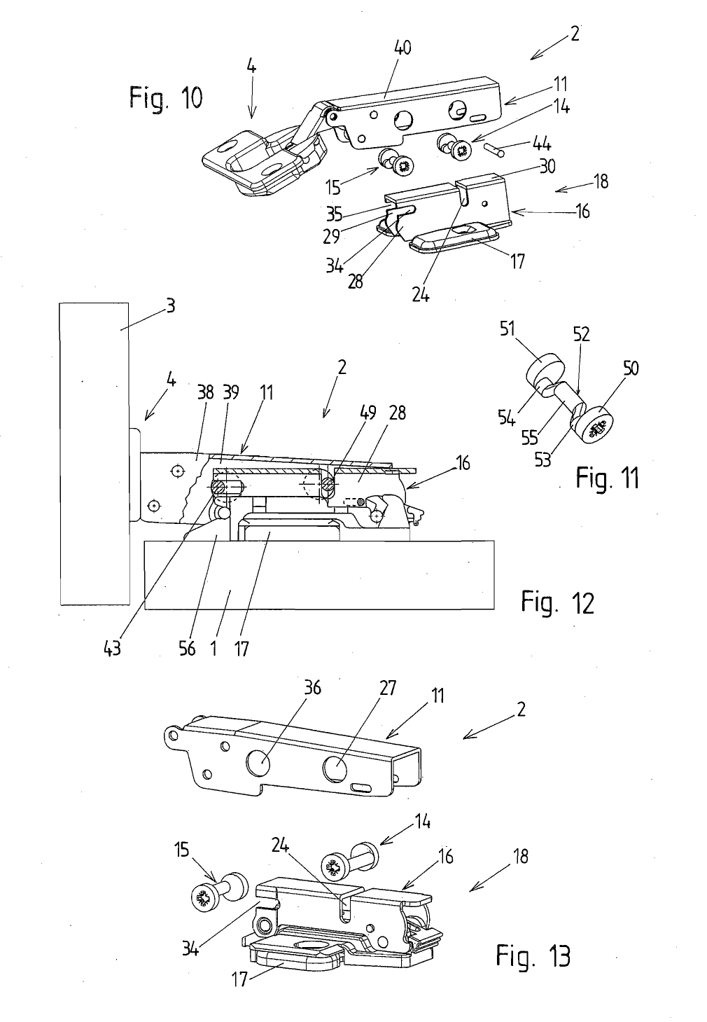

A first exemplary embodiment of the invention is shown in FIGS. 1 through 10. The furniture hinge comprises a carcass hinge part 2 that can be mounted to a furniture carcass 1, a door leaf hinge part 4 that can be mounted to a door leaf 3 of a piece of furniture, and articulated levers 5, 6, each of which can be pivoted around parallel pivot axes 7, 8, 9, 10, and connected, on the one hand, to a hinge arm 11 of the carcass hinge part 2, and on the other hand to a door leaf hinge part 4. Such furniture hinge parts with two articulated levers 5, 6 are known. The invention is not limited to a certain number of articulated levers. For example, one or more articulated levers 5, 6 can be mounted pivotally at the hinge arm 11 of the carcass hinge part 2 and can be connected to one of more additional articulated levers, which in turn are mounted pivotally at the door leaf hinge part 4.

The door leaf hinge part 4 can be embodied in form of a conventional hinge cup shown, for example, protruding in a recess in the door leaf 3 and provided with laterally protruding fastening flanges 12, 13, which are provided with threaded holes for screwing the door leaf hinge part 4 to the door leaf 3.

The furniture hinge can be embodied in a conventional manner closing automatically (over a last section of its closing motion.) using a spring arrangement. A dampening arrangement, not shown in the figures, may be provided to dampen the closing motion.

In the exemplary embodiment according to FIGS. 1 through 10 the hinge arm 11 of the carcass hinge part 2 is adjustable via a first and a second eccentric 14, 15 in reference to a retaining part 16 of the carcass hinge part 2, which is mounted to the furniture carcass 1 via a screw plate 17. In this exemplary embodiment, the retaining part 16 therefore forms a portion of a so-called assembly plate and/or a so-called assembly rack 18. The screw plate 17 is provided with a support surface 19 located in the contact plane 20 of the carcass hinge part 2, by which it can be connected to the furniture carcass 1. Screw holes 21 are provided for screwing it to the furniture carcass 1.

The first eccentric 14, acting between the hinge arm 11 and the retaining part 16, serves for the depth adjustment of the door leaf 3 in reference to the furniture carcass 1. For this purpose, the hinge arm 11 is adjusted in the direction of its longitudinal extension in reference to the retaining part 16. Here, the door leaf 3 is essentially adjusted perpendicularly in reference to the plane 22 of the opening of the furniture carcass 1 (cf. FIGS. 1 through 3). In FIG. 3 a distance x between the furniture carcass 1 and the door leaf 3 is shown modified in reference to FIG. 1 by the depth adjustment.

The pivot axis 23 of the first eccentric 14 is positioned parallel in reference to the pivot axes 7-10 of the articulated lever 5, 6.

The first eccentric 14 for the depth adjustment cooperates with at least one oblong hole 24, 25 in the retaining part 16 and at least one circular hole 26, 27 in the hinge arm 11. It is also possible to provide the at least one oblong hole 24, 25 in the hinge arm 11 and the at least one round hole 26, 27 in the retaining part 16. The at least one oblong hole 24, 25 extends in the longitudinal direction essentially aligned perpendicular in reference to the contact plane 20 of the carcass hinge part 2 and/or the longitudinal extension of the hinge arm 11.

“Essentially perpendicular” means here that the deviation from the right angle is preferably no greater than ±20°.

The longitudinal extension of the at least one oblong hole 24, 25 is also perpendicular in reference to the pivot axes 7-10 of the articulated levers 5, 6.

In the exemplary embodiment shown, the retaining part 16 is provided with two lateral bars 28, 29 spaced apart from each other and extending in the direction of the pivot axes 7-10 of the articulated lever 5. In each of the lateral bars 28, 29, the oblong hole 24, 25 is penetrated by a first eccentric 14. The lateral bars 28, 29 are connected to each other by a connection bar 30 at their edge spaced apart from the contact plane 20. Said bar is penetrated by a slot 31, by which the first eccentric 14 can be inserted into the oblong holes 24, 25 of the lateral bars 28, 29. The slot 31 is therefore located at the position of the connection bar 30 at which the oblong holes 24, 25 are open towards the edge of the lateral bars 28, 29 distanced from the contact plane 20.

The hinge arm 11 is embodied U-shaped and has lateral bars 38, 39 at both sides of the lateral bars 28, 29 of the retaining part 16, which are connected to each other by a connecting bar 40. Each of the lateral bars 38, 39 of the hinge arm 11 has a base hole 26, 27.

The first eccentric 14 has eccentric heads 47, 48, which are connected to each other by an eccentric shaft 49. The eccentric heads 47, 48 are located in the round holes 26, 27 and the eccentric shaft 49 penetrates the oblong holes 24, 25.

In an alternate arrangement, the round holes in the lateral bars 28, 29 are penetrated by the eccentric shaft 49 and the eccentric heads 47, 48 are arranged in the oblong holes in the lateral bars 38, 39.

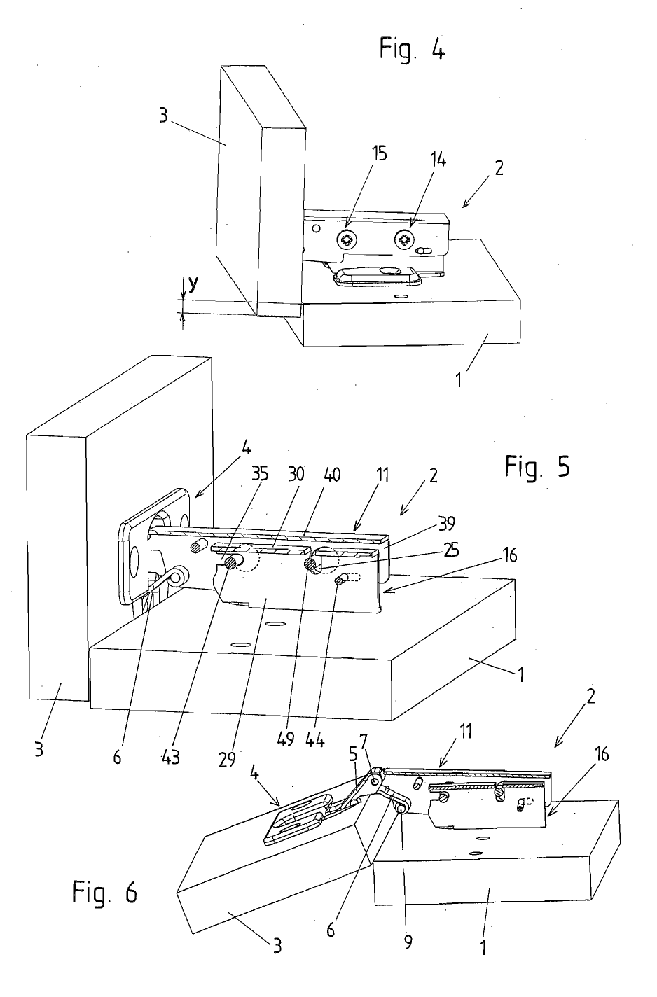

The second eccentric 15 serves to the lateral adjustment (=side adjustment or support adjustment) of the door leaf 3 in reference to the furniture carcass 1. In this lateral adjustment the end of the carcass hinge part 2 facing the door leaf hinge part 4 is adjusted in a direction essentially perpendicular in reference to the contact plane 20. “Essentially perpendicular” means here that the adjustment direction preferably deviates no more than ±20° from the perpendicular of the contact plane 20. The door leaf 3 is here essentially parallel in reference to the plane 22 of the opening of the furniture carcass 1 and displaced perpendicular in reference to the pivot axes 7-10 of the articulated levers 5, 6 (cf. FIGS. 1, 2, and 4.) FIG. 4 shows a support y of the door leaf 3, changed by lateral adjustment, on the side wall of the furniture carcass 1, at which the carcass hinge part 2 is mounted. For interior door leafs, the distance of the door leaf from the lateral wall of the furniture carcass, at which the carcass hinge part 2 is mounted, can be adjusted by the lateral adjustment.

For a lateral adjustment, the hinge arm 11 is swiveled around a pivot axis 32, which is parallel in reference to the pivot axes 7-10 of the articulated lever 5, 6, in reference to the retaining part 16 via a second eccentric 15. The pivot axis 33 of the second eccentric 15 is aligned parallel in reference to the pivot axes 7-10 of the articulated levers 5, 6, and thus parallel in reference to the pivot axes 23 of the first eccentric 14.

The pivot axis 33 of the second eccentric 15 is arranged parallel to the pivot axis 32, around which the hinge arm 11 can be pivoted in reference to the retaining part 16 via the second eccentric 15.

The second eccentric 15 cooperates with at least one oblong hole 34, 35, which is arranged in the retaining part 16, and with at least one round hole 36, 37, which is arranged in the hinge arm 11. At least one oblong hole 34, 35 can also be arranged in the hinge arm 11 and at least one round hole 36, 37 in the retaining part 16. The longitudinal extension of at least one oblong hole 34, 35 is positioned essentially parallel in reference to the longitudinal extension of the hinge arm 11 and/or essentially parallel in reference to the support plane 20 of the carcass hinge part 2 and perpendicular in reference to the pivot axes 7-10 of the articulated levers 5, 6. “Essentially parallel” here means that the deviation from the parallel is preferably no greater than ±20°.

In the exemplary embodiment shown, two of the oblong holes 34, 35 are provided in the lateral bars 28, 29 of the retaining part 16. They preferably open at the edge of the lateral bar 28, 29, respectively facing the door leaf hinge part 4, so that the second eccentric 15 can be inserted from this edge into the oblong holes 34, 35. Furthermore, two of the round holes 36, 37 are provided in the lateral bars 38, 39 of the hinge arm 11. The second eccentric 15 has two eccentric heads 41, 42 located in the round holes 36, 37, which are connected via an eccentric shaft 43 penetrating the oblong holes 34, 35.

In case of an arrangement of the round holes in the lateral bars 28, 29 they would be penetrated by the eccentric shaft 43 and the eccentric heads 41, 42 would be arranged in the oblong holes in the lateral bars 38, 39.

The pivot axis 32 for the lateral adjustment is farther distanced from the end of the carcass hinge part 2 facing the door leaf than the second eccentric 15 and is located in the proximity of the first eccentric 14.

The first eccentric 14 is spaced farther from the end of the carcass hinge part 2 facing the door leaf than the second eccentric 15.

In reference to the retaining part 16, the hinge arm 11 is guided in a displaceable manner in a direction in an essentially parallel in reference to the contact plane 20 and perpendicular in reference to the pivot axes 7-10 of the articulated levers 5, 6 and/or essentially parallel to its longitudinal direction. “Essentially parallel” means that the deviation from the parallel is preferably no greater than ±20°. For this displaceable guidance, preferably at least one pin 44 is provided at the retaining part 16 which extends into at least one oblong hole 45, 46 embodied at the hinge arm 11, with the oblong hole extending in the displacement direction, i.e. essentially in the direction of the longitudinal extension of the hinge arm 11. At least one pin 44 could be mounted at the hinge arm 11 and extend into at least one oblong hole arranged at the retaining part 16 and extending in the displacement direction. In the exemplary embodiment shown, a pin 44 is provided which penetrates the holes in the two lateral bars 28, 29 of the retaining part 16 and is held thereby and protrudes in the oblong holes 45, 46 in the two lateral bars 38, 39 of the hinge arm 11. For example, at both lateral bars 28, 29 of the retaining part 16 separate protruding pins may also be provided.

At least one pin 44 forms the pivot axis 32, around which the hinge arm 11 is pivotal in reference to the retaining part 16 for a lateral adjustment.

The displaceable guidance of the hinge arm 11 in reference to the retaining part 16 is further caused by the second eccentric 15 penetrating at least one oblong hole 34, 35 aligned in the displacement direction.

The adjusted position of the hinge arm 11 in reference to the retaining part 16 is upheld by friction between these two parts.

For vertically adjusting the first eccentric 14 it is pivoted around its pivot axis 23, by which the hinge arm 11 is displaced in its longitudinal direction in reference to the retaining part 16. For the lateral adjustment the second eccentric 15 is pivoted around its pivot axis 33, causing the hinge arm 11 to be pivoted around the pivot axis 32 in reference to the retaining part 16.

In the area between the eccentric shaft 49, 43 and the contact plane 20, a continuous hollow space remains inside the retaining part 16, extending in the longitudinal direction of the hinge arm 11, extending from the end of the retaining part 16 facing the door leaf through the interior space of the hinge arm 11 to the articulated lever mechanisms. In this free space other built in elements can be implemented, for example a dampening cylinder, a touch-latch, or another spring device.

FIG. 11 shows a slightly modified embodiment of the eccentrics 14, 15. Here, the eccentric shaft 52 located between the eccentric heads 50, 51, following the eccentric heads 50, 51, is provided with one eccentric section 53, 54 each and a central section 55, connected to the eccentric sections 53, 54. The free space in the carcass hinge part 2 can thus be maximized.

In the exemplary embodiment according to FIGS. 1-10 the retaining part 16 is an assembly rack 18 (=assembly plate). The retaining part 16 can here be connected in a fixed manner to the screw plate 17, as shown. A connection adjustable in the direction of the pivot axes 7-10 of the articulated levers 5, 6 can also be provided in order to allow a vertical adjustment of the door leaf 3 in reference to the furniture carcass 1. Such adjustable connections, in which the adjustment occurs e.g., via an eccentric, with its pivot axis being perpendicular in reference to the contact plane 20, are known, for example from prior art stated at the outset. In the simplest case, the vertical adjustment can be achieved such that the screw holes 21 of the screw plate 17 are embodied as oblong holes aligned parallel in reference to the pivot axes 7-10 of the articulated levers 5, 6.

FIGS. 12 and 13 show an exemplary embodiment in which the retaining part 16, which is adjustable in reference to the hinge arm 11 via the eccentrics 14, 15 for the depth adjustment and for the lateral adjustment, is embodied as a clip, which can be snapped onto a clip accepting part 56 of the assembly rack 18. Such clip connections are known. The clip accepting part 56 can be connected to the screw plate 17 of the assembly rack 18 in a fixed manner or adjustable in the direction of the height adjustment, for example via an eccentric plate.

### LEGEND

1 furniture carcass

2 carcass hinge part

3 door leaf

4 door leaf hinge part

5 articulated lever

6 articulated lever

7 pivot axis

8 pivot axis

9 pivot axis

10 pivot axis

11 hinge arm

12 mounting flange

13 mounting flange

14 first eccentric

15 second eccentric

16 retaining part

17 screw plate

18 assembly rack

19 contact surface

20 contact plane

21 screw hole

22 plane

23 pivot axis

24 oblong hole

25 oblong hole

26 round hole

27 round hole

28 lateral bar

29 lateral bar

30 connecting bar

31 slot

32 pivot axis

33 rotary axis

34 oblong hole

35 oblong hole

36 round hole

37 round hole

38 lateral bar

39 lateral bar

40 connecting bar

41 eccentric head

42 eccentric head

43 eccentric shaft

44 pin

45 oblong hole

46 oblong hole

47 eccentric head

48 eccentric head

49 eccentric shaft

50 eccentric head

51 eccentric head

52 eccentric shaft

53 eccentric section

54 eccentric section

55 centric section

56 clip accepting part

1. A furniture hinge comprising a carcass hinge part (2) that can be mounted to a furniture carcass (1), a door leaf hinge part (4) that can be mounted to a door leaf (3), and at least one articulated lever (5, 6) for an articulated connection of the carcass hinge part (2) to the door leaf hinge part (4), the articulated lever (5, 6) is connected to a hinge arm (11) of the carcass hinge part (2) in an articulated manner pivotal around a pivot axis (7, 9), the hinge arm (11) is adjustable in a direction of a longitudinal extension thereof in reference to a retaining part (16) of the carcass hinge part (2) for a depth adjustment of the door leaf (3) in reference to the furniture carcass (1) via an eccentric (14) acting between the hinge arm (11) and the retaining part (16), and a pivot axis (23) of the eccentric (14) is positioned parallel in reference to the pivot axis (7, 9) of the at least one articulated lever (5, 6).

2. A furniture hinge according to claim 1, wherein the eccentric (14) cooperates with at least one oblong hole (24, 25), which is arranged in one of the retaining part (16) or the hinge arm (11) and cooperates with at least one round hole (26, 27), which is arranged in the other of the retaining part or the hinge arm (11, 16).

3. A furniture hinge according to claim 2, wherein a longitudinal extension of the at least one oblong hole (24, 25) is arranged at least essentially perpendicular in reference to a contact plane (20) of the carcass hinge part (2) at the furniture carcass (1).

4. A furniture hinge according to claim 2, wherein the retaining part (16) is provided with two lateral bars (28, 29), spaced apart from each other in a direction of the pivot axis (7, 9) of the at least one articulated lever (5, 6), and each of the lateral bars (28, 29) is provided with one of the oblong holes (24, 25) penetrated by the eccentric (14).

5. A furniture hinge according to claim 4, wherein the lateral bars (28, 29) of the retaining part (16), at edges thereof facing away from a contact plane (20) of the carcass hinge part (2), to which the carcass hinge part (2) can be connected to the furniture carcass (1) for mounting to the furniture carcass (1), are connected to each other by a connection bar (30), which is provided with a slot (31) for introducing the eccentric (14) into the oblong holes (24,25) of the lateral bars (28, 29).

6. A furniture hinge according to claim 4, wherein the hinge arm (11) is embodied U-shaped and is provided with lateral bars (38, 39) arranged at both sides of lateral bars (28, 29) of the retaining part (16).

7. A furniture hinge according to claim 6, wherein each of the lateral bars (38, 39) of the hinge arm (11) is provided with a round hole (26, 27) for accepting an eccentric head (47, 48) of the eccentric (14).

8. A furniture hinge according claim 1, wherein the hinge arm (11) is guided in a displaceable manner in a direction essentially parallel to a longitudinal extension thereof in reference to the retaining part (16).

9. A furniture hinge according to claim 8, wherein for displaceable guidance of the hinge arm (11) in reference to the retaining part (16) at least one pin (44) is provided at the retaining part (16) or at the hinge arm (11) protruding into at least one oblong hole (45, 46) arranged at the other one of the two parts (16, 11), which extends essentially in a direction of the longitudinal direction of the hinge arm (11).

10. A furniture hinge according to claim 1, wherein the hinge arm (11) is adjustable in reference to the retaining part (16) via a second eccentric (15) acting between the hinge arm (11) and the retaining part (16) for lateral adjustment of the door leaf (3) in reference to the furniture carcass (1), with a pivot axis (33) of the second eccentric being arranged parallel in reference to the pivot axis (7, 9) of the at least one articulated lever (5, 6).

11. A furniture hinge according to claim 10, wherein the hinge arm (11) is pivotal around a pivot axis (32) in reference to the retaining part (16) via the second eccentric (15), with the pivot axis being arranged parallel in reference to the pivot axis (7, 9) of the at least one articulated lever (5, 6).

12. A furniture hinge according to claim 11, wherein the pivot axis (32), around which the hinge arm (11) is pivotal via the second eccentric (15) in reference to the retaining part (16), comprises at least one pin (44) for a displaceable guidance of the hinge arm (11) in reference to the retaining part (16).

13. A furniture hinge according to claim 10, wherein the second eccentric (15) cooperates with at least one oblong hole (34, 35), arranged in one of the retaining part (16) or the hinge arm (11), and cooperates with at least one round hole (36, 37), arranged in the other of the retaining part or the hinge arm (16, 11).

14. A furniture hinge according to claim 13, wherein a longitudinal extension of the at least one oblong hole (34, 35) cooperating with the second eccentric (15) is essentially arranged parallel in reference to the contact plane (20) of the carcass hinge part (2) at the furniture carcass (1) and perpendicular in reference to the pivot axis (7, 9) of the articulated lever (5, 6).

15. A furniture lever according to claim 13, wherein each of the lateral bars (28, 29) of the retaining part (16) is provided with an oblong hole (34, 35) penetrated by the second eccentric (15).

16. A furniture hinge according to claim 15, wherein each of the lateral bars (38, 39) of the hinge arm (11) is provided with a round hole (36, 37) for accepting an eccentric head (41, 42) of the second eccentric (15).

17. A furniture hinge according to claim 10, wherein the second eccentric (15) for the lateral adjustment is located closer to an end of the hinge arm (11) facing the door leaf than the eccentric (14) for the depth adjustment.

18. A furniture hinge according to claim 1, wherein the retaining part (16) is a clip part, which is snapped into a clip accepting part (56) of an assembly rack (18) that can be screwed to the furniture carcass.
